(19) United States
(12) Patent Application Publication
(10) Pub. No.: US 2019/0023183 A1
(43) Pub. Date: Jan. 24, 2019

(54) VEHICLE MIRROR DEVICE

(71) Applicant: KABUSHIKI KAISHA TOKAI-RIKA-DENKI-SEISAKUSHO, Aichi (JP)

(72) Inventors: Shigeki YOSHIDA, Aichi (JP); Takashi ICHIKAWA, Aichi (JP)

(21) Appl. No.: 16/070,458

(22) PCT Filed: Dec. 26, 2016
(86) PCT No.: PCT/JP2016/088803

§ 371 Date: Jul. 16, 2018

(30) Foreign Application Priority Data
Jan. 22, 2016 (JP) 2016-010833

(51) Int. Cl. B60R 1/072

(52) U.S. Cl. CPC B60R 1/072

(57) ABSTRACT

In a vehicle door mirror device, an attachment wall, a sliding wall, a swivel wall, a reinforcing plate, and a reinforcing cylinder reinforce a mirror. Moreover, plating is formed on surfaces of the attachment wall, the sliding wall, the swivel wall, the reinforcing plate, and the reinforcing cylinder. This enables the attachment wall, the sliding wall, the swivel wall, the reinforcing plate, and the reinforcing cylinder to effectively reinforce the mirror, and enables the rigidity of the mirror face to be increased.

### TECHNICAL FIELD

The present invention relates to a vehicle mirror device including a mirror body provided at a vehicle.

### BACKGROUND ART

In a vehicle door mirror described in Japanese Patent Application Laid-Open (JP-A) No. 2012-206529, a reflective face of a mirror body is configured by plating. When the mirror body is swung, a portion of the mirror body that fits to a coupling member slides with respect to the coupling member.

Note that in vehicle door mirrors such as this, it is preferable to increase the rigidity of the reflective face of the mirror body.

### SUMMARY OF INVENTION

### Technical Problem

In consideration of the above circumstances, an object of the present invention is to obtain a vehicle mirror device capable of increasing the rigidity of a mirror face.

### Solution to Problem

A vehicle mirror device of a first aspect of the present invention includes a mirror body that is provided at a vehicle, a mirror face that is provided at the mirror body and that is configured by plating, and a sliding portion that is provided at the mirror body, that has plating provided at a surface thereof, and that slides when the mirror body is moved.

A vehicle mirror device of a second aspect of the present invention is the vehicle mirror device of the first aspect of the present invention, further including an inner support portion that supports the sliding portion, which is provided at a central side of the mirror face of the mirror body.

A vehicle mirror device of a third aspect of the present invention is the vehicle mirror device of the first aspect or the second aspect of the present invention, further including an outer support portion that supports the sliding portion, which is provided at an outer peripheral side of the mirror face of the mirror body.

A vehicle mirror device of a fourth aspect of the present invention is the vehicle mirror device of any one of the first aspect to the third aspect of the present invention, further including a moving member that engages with the sliding portion. The mirror is moved by the sliding portion moving.

A vehicle mirror device of a fifth aspect of the present invention includes a mirror body that is provided at a vehicle, a mirror face that is provided at the mirror body and that is configured by plating, and a surface portion that is provided on a surface of the mirror body to at least one of a perimeter of the mirror face or an opposite side from the mirror face, and that is configured by plating.

A vehicle mirror device of a sixth aspect of the present invention is the vehicle mirror device of any one of the first aspect to the fifth aspect of the present invention, further including a reinforcing portion that is provided at the mirror body, that reinforces the mirror face, and that has plating provided at a surface thereof.

### Advantageous Effects

In the vehicle mirror device of the first aspect of the present invention, the mirror face is provided at the mirror body, and the mirror face is configured by plating. The sliding portion is also provided at the mirror body, and the sliding portion slides when the mirror body is moved.

Note that the plating is provided at the surface of the sliding portion. This enables the sliding portion to effectively reinforce the mirror face, enabling the rigidity of the mirror face to be increased. This also enables sliding resistance of the sliding portion to be reduced, enabling movability of the mirror body to be improved.

In the vehicle mirror device of the second aspect of the present invention, the inner support portion supports the sliding portion, which is provided at the central side of the mirror face of the mirror body. This enables sliding resistance of the sliding portion with respect to the inner support portion to be reduced.

In the vehicle mirror device of the third aspect of the present invention, the outer support portion supports the sliding portion, which is provided at the outer peripheral side of the mirror face of the mirror body. This enables sliding resistance of the sliding portion with respect to the outer support portion to be reduced.

In the vehicle mirror device of the fourth aspect of the present invention, the mirror body is moved by moving the moving member.

Note that the moving member is engaged with the sliding portion. This enables sliding resistance of the sliding portion with respect to the moving member to be reduced.

In the vehicle mirror device of the fifth aspect of the present invention, the mirror face is provided at the mirror body and the mirror face is configured by plating.

Note that the surface portion is provided on the surface of the mirror body to at least one of the perimeter of the mirror face or the opposite side from the mirror face, and that the surface portion is configured by plating. This enables the mirror body to be reinforced by the surface portion, enabling the rigidity of the mirror face to be increased.

In the vehicle mirror device of the sixth aspect of the present invention, the reinforcing portion is provided at the mirror body, and the reinforcing portion reinforces the mirror face.

Note that the plating is provided at the surface of the reinforcing portion. This enables the mirror face to be effectively reinforced by the reinforcing portion, enabling the rigidity of the mirror face to be increased.

### BRIEF DESCRIPTION OF DRAWINGS

FIG. 1 is an exploded perspective view of a vehicle door mirror device according to an exemplary embodiment of the present invention, as viewed from a vehicle front side and vehicle width direction inside.

FIG. 2 is a cross-section of relevant portions of the vehicle door mirror device according to the exemplary embodiment of the present invention, as viewed from a vehicle width direction outside.

FIG. 3 is a perspective view of a visor body of the vehicle door mirror device according to the exemplary embodiment of the present invention, as viewed from a vehicle rear side and vehicle width direction inside.

FIG. 4 is a perspective view of a mirror body of the vehicle door mirror device according to the exemplary embodiment of the present invention, as viewed from the vehicle front side and vehicle width direction inside.

### DESCRIPTION OF EMBODIMENTS

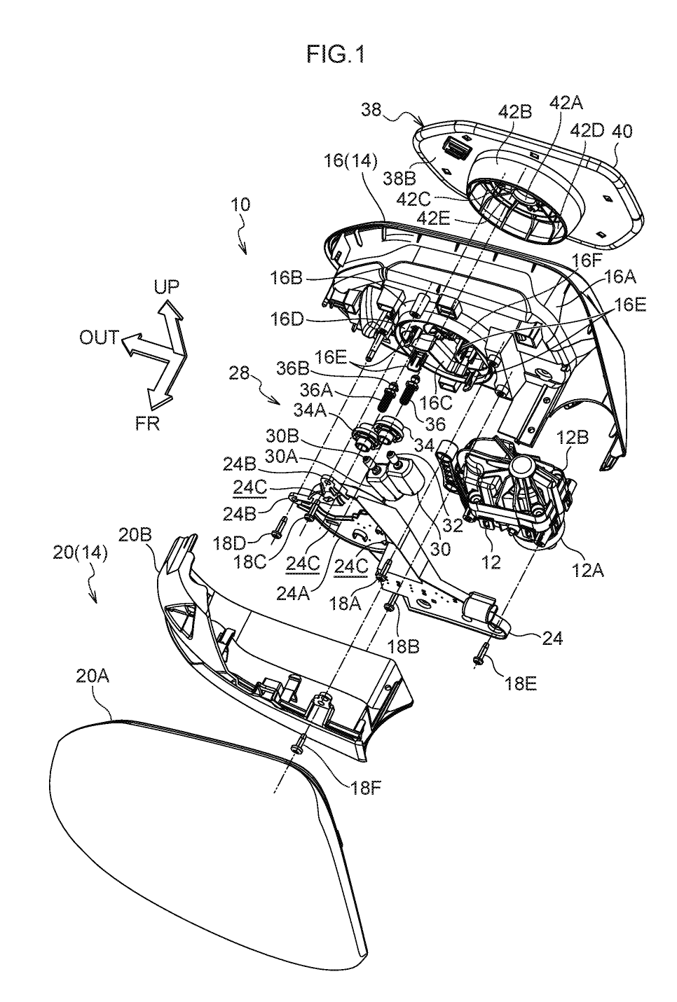

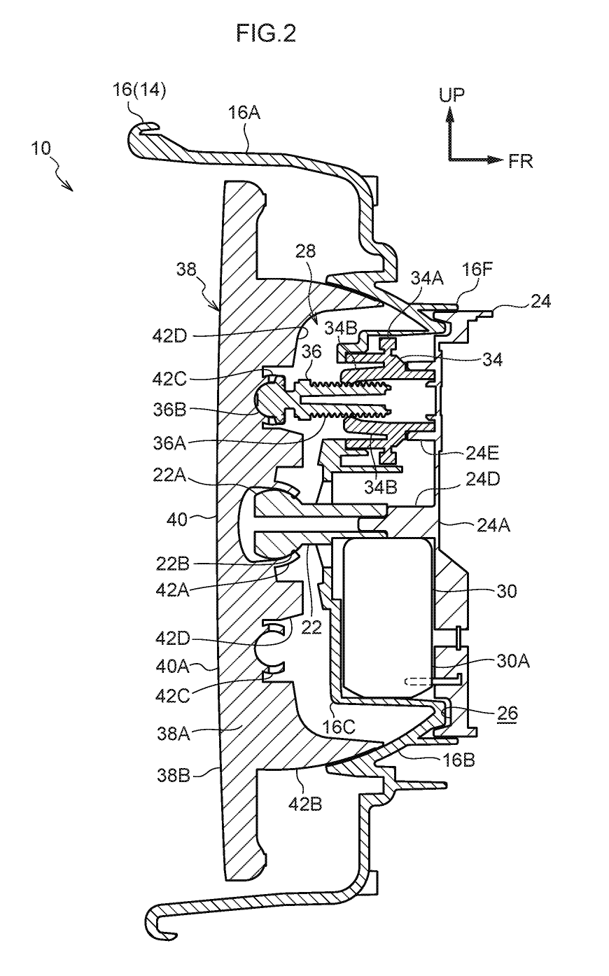

FIG. 1 is an exploded perspective view of a vehicle door mirror device 10, which serves as a vehicle mirror device, according to an exemplary embodiment of the present invention, as viewed from a vehicle front side and vehicle width direction inside (vehicle left side). FIG. 2 is a cross-section of relevant portions of the vehicle door mirror device 10, as viewed from a vehicle width direction outside (vehicle right side). Note that in the drawings, the arrow FR indicates toward the vehicle front, the arrow OUT indicates the vehicle width direction outside, and the arrow UP indicates upwards.

The vehicle door mirror device 10 according to the present exemplary embodiment is supported at an outside of a door (front side door, vehicle body side) of a vehicle.

As illustrated in FIG. 1, the vehicle door mirror device 10 includes a stowing mechanism 12. A stand 12A, which serves as a support member, is provided to the stowing mechanism 12. The vehicle door mirror device 10 is supported on the door by the stand 12A being supported at a vehicle front side end of an up-down direction intermediate portion of the door. A swing body 12B is supported by the stand 12A. The swing body 12B is swung about a vertical axis with respect to the stand 12A by electrically operating the stowing mechanism 12. The swing body 12B is electrically connected to a controller (not illustrated in the drawings) on the vehicle body side, and the stowing mechanism 12 is electrically operated under control by the controller.

A visor 14, which is made from resin and serves as an outer peripheral body, is supported on the swing body 12B of the stowing mechanism 12. A visor body 16, which serves as a support body, is provided to the visor 14. The swing body 12B is fixed to a vehicle front side of a vehicle width direction inside end portion of the visor body 16, such as by fastening a first screw 18A and a second screw 18B, which serve as assembly members. A visor cover 20, which has a curved plate shape and serves as a covering member, is assembled at the vehicle front side of the visor body 16 with reinforcement 24, described below, interposed therebetween. An outer periphery of the visor cover 20 is fitted to an outer periphery of the visor body 16, so that the visor cover 20 covers the vehicle front side of the visor body 16. An upper cover 20A is provided at an upper side of the visor cover 20, and a lower cover 20B is provided at a lower side thereof. The visor cover 20 is configured by combining the upper cover 20A and the lower cover 20B.

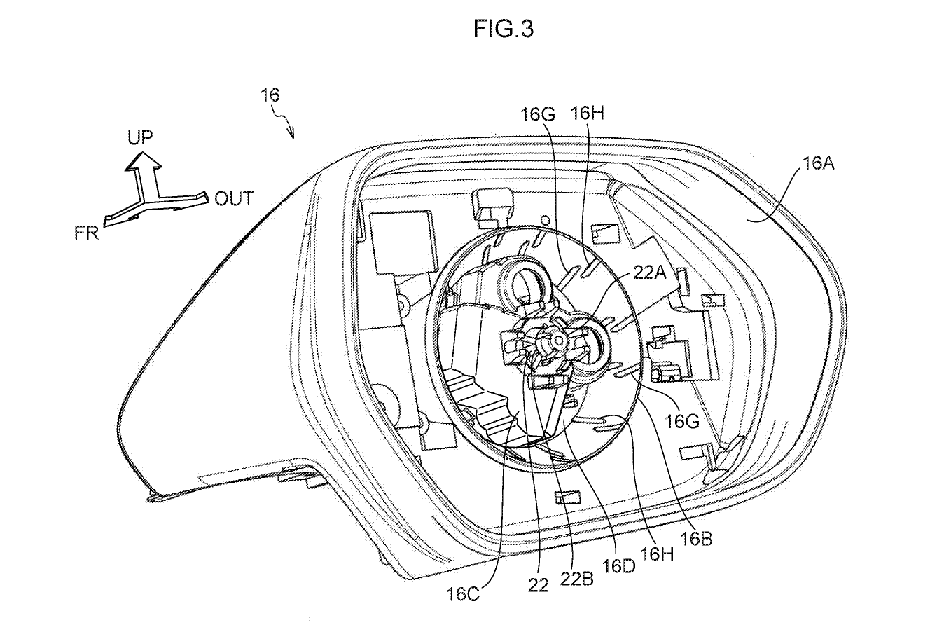

As illustrated in FIG. 1 to FIG. 3, a substantially cuboid box-shaped housing wall 16A, which serves as a housing section, is provided to the visor body 16. The inside of the housing wall 16A is open toward the vehicle rear side.

A support wall 16B (case lower portion), which serves as an outer support portion, is integrally provided to a vehicle front side wall (bottom wall) of the housing wall 16A. The support wall 16B projects out to the vehicle front side and vehicle rear side of the vehicle front side wall of the housing wall 16A. The support wall 16B is substantially cylindrical in shape, and is disposed such that a center axis line of the support wall 16B is parallel to the vehicle front-rear direction. The support wall 16B has a spherical wall shape, with an internal diameter dimension of the support wall 16B gradually increasing on progression toward the vehicle rear.

Plural, elongated plate shaped support protrusions 16G, which serve as support locations, are integrally provided to an inner peripheral face of the support wall 16B. The support protrusions 16G project out from the inner peripheral face of the support wall 16B toward the center of the support wall 16B, and projection end faces 16H (slide faces) thereof are shaped as spherical faces centered about the center of the support wall 16B. Plural (three or more) of the support protrusions 16G are disposed at even spacings around the circumferential direction of the support wall 16B. Plural (two in the present exemplary embodiment) of the support protrusions 16G are disposed in the center axis line direction of the support wall 16B (vehicle front-rear direction). The plural support protrusions 16G in the center axis line direction of the support wall 16B are disposed so as to partially overlap each other in the center axis line direction of the support wall 16B. The support protrusions 16G are disposed along the entire support wall 16B in the center axis line direction.

A covering wall 16C (case upper portion), which has a receptacle shape and serves as a covering portion, is provided inside the support wall 16B. The entire periphery at a vehicle front side end of the covering wall 16C is integrated to the entire periphery at a vehicle front side end of the support wall 16B. A coupling wall 16D having a flat plate shape is integrally provided between the vehicle front side end of the covering wall 16C and the vehicle front side end of the support wall 16B. The coupling wall 16D couples together the vehicle front side end of the covering wall 16C and the vehicle front side end of the support wall 16B at parts where the vehicle front side end of the covering wall 16C and the vehicle front side end of the support wall 16B are not directly integrated together. The inside of the covering wall 16C is open toward the vehicle front side of the support wall 16B. The inside of the covering wall 16C is thereby open toward the vehicle front side of the housing wall 16A.

A predetermined number (four in the present exemplary embodiment) of rectangular plate shaped limiting plates 16E, serving as limiting portions, are integrally provided to the coupling wall 16D. The limiting plates 16E project out from the coupling wall 16D toward the vehicle front side. The predetermined number of limiting plates 16E are disposed at substantially even spacings around the circumferential direction of the support wall 16B. The limiting plates 16E are disposed so as to intersect the radial direction of the support wall 16B.

A fitting cylinder 16F, which has a circular cylindrical shape and serves as a fitting portion, is integrally provided to a vehicle front-rear direction intermediate portion on an outer peripheral face of the support wall 16B. The fitting cylinder 16F projects out from the support wall 16B toward the vehicle front side and is disposed coaxially to the support wall 16B.

A retention tube 22, which has a substantially circular tube shape and serves as an inner support portion (retention portion), is integrally provided to a vehicle rear side wall (bottom wall) of the covering wall 16C. The retention tube 22 projects out to the vehicle front side and the vehicle rear side of the vehicle rear side wall of the covering wall 16C, and is disposed coaxially to the support wall 16B. A retention ball 22A having a substantially spherical shape is provided at a vehicle rear side end portion of the retention tube 22. A peripheral face at a vehicle front side portion of the retention ball 22A configures a spherical face shaped retention face 22B (slide face) with its center aligned with the center of the support wall 16B.

The reinforcement 24, which is substantially made from resin in an elongated plate shape and serves as a reinforcement body, is provided at the vehicle front side of the visor body 16 and of the swing body 12B of the stowing mechanism 12. A vehicle width direction intermediate portion of the reinforcement 24 is fixed, together with the swing body 12B, to the visor body 16 by fastening the first screw 18A and the second screw 18B.

A pair of assembly plates 24B, each of which has a triangular plate shape and serves as an assembly portion, are integrally provided to a vehicle width direction outside portion of the reinforcement 24. The pair of assembly plates 24B respectively project out to the upper side and the vehicle width direction outside of the reinforcement 24. The vehicle width direction outside portion of the reinforcement 24 at the pair of assembly plates 24B is fixed to the visor body 16 by fastening a third screw 18C and a fourth screw 18D, each serving as an assembly member. A vehicle width direction inside end portion of the reinforcement 24 is fixed to the swing body 12B by fastening a fifth screw 18E, serving as an assembly member.

The reinforcement 24 has a higher rigidity than the visor body 16, and the reinforcement 24 reinforces the visor body 16 and the swing body 12B. The visor cover 20 (lower cover 20B) of the visor 14 is fixed to the reinforcement 24 by fastening a sixth screw 18F, serving as a fixing member. The visor cover 20 is thereby assembled to the visor body 16 through the reinforcement 24, as described above.

An electrical circuit (not illustrated in the drawings) is provided to the reinforcement 24. The electrical circuit is electrically connected to the controller.

A bottom wall portion 24A, which has a circular plate shape and serves as a blocking portion, is provided to a vehicle width direction outside portion of the reinforcement 24. A recess portion 26, which serves as an insertion portion and has a rectangular profile in cross-section, is formed around the entire periphery of an outer peripheral portion at a vehicle rear side face of the bottom wall portion 24A. The bottom wall portion 24A is fitted inside the fitting cylinder 16F of the visor body 16, and a vehicle front side end of the support wall 16B of the visor body 16 is inserted into the recess portion 26. The outer peripheral face of the support wall 16B is fitted to an outer peripheral face of the recess portion 26. The vehicle front side of the support wall 16B and of the covering wall 16C of the visor body 16 are thereby covered and blocked off by the bottom wall portion 24A.

A predetermined number (four in the present exemplary embodiment) of limiting holes 24C, each having a rectangular shape and serving as a limiter portion, are formed penetrating the bottom wall portion 24A. The predetermined number of limiting holes 24C are disposed at substantially even spacings around the circumferential direction of the bottom wall portion 24A and are each disposed so as to intersect the radial direction of the bottom wall portion 24A. The limiting plates 16E of the visor body 16 are inserted (fitted) into the limiting holes 24C, thereby limiting movement of the bottom wall portion 24A in the circumferential direction and the radial direction with respect to the visor body 16.

A fit-insertion column 24D, which has a substantially circular column shape and serves as a fit-insertion portion, is integrally provided at a central portion of the bottom wall portion 24A. The fit-insertion column 24D projects out from the bottom wall portion 24A toward the vehicle rear side, and is disposed coaxially to the bottom wall portion 24A. A leading end portion of the fit-insertion column 24D has a reduced diameter. The leading end portion of the fit-insertion column 24D is fit-inserted inside the retention tube 22 of the visor body 16 from the vehicle front side.

Circular tube shaped support tubes 24E are integrally provided further toward the radial direction inside of the bottom wall portion 24A than the assembly plates 24B at an upper portion (or alternatively a lower portion) and vehicle width direction outside portion (or alternatively a vehicle width direction inside portion) of the bottom wall portion 24A. Each of the support tubes 24E projects out from the bottom wall portion 24A toward the vehicle rear side, and is disposed with a center axis line parallel to the center axis line of the bottom wall portion 24A.

A mirror face adjustment mechanism 28, which serves as an operating mechanism, is retained between the covering wall 16C of the visor body 16 and the bottom wall portion 24A of the reinforcement 24.

A pair of motors 30, which serve as drive means, are provided in the mirror face adjustment mechanism 28. A main body 30A of each of the motors 30 is retained in a state clamped between the covering wall 16C and the bottom wall portion 24A. An output shaft 30B extends from the main body 30A, and a worm 32, which serves as an output member, is fixed to the output shaft 30B. The electrical circuit of the reinforcement 24 is electrically connected to the main bodies 30A. The motors 30 are driven under control of the controller to electrically operate the mirror face adjustment mechanism 28.

A pair of wheel drives 34, which are each made from resin in a substantially circular tube shape and serve as transmission members, are provided in the mirror face adjustment mechanism 28. In a state in which a vehicle front side portion of each of the wheel drives 34 is fit-inserted into the support tubes 24E of the bottom wall portion 24A, the wheel drives 34 are clamped between the covering wall 16C and the bottom wall portion 24A and retained so as to be rotatable about their axes.

A worm wheel 34A is formed coaxially to an outer peripheral edge at an intermediate portion in the axial direction (vehicle front-rear direction) of each of the wheel drives 34. The worm wheels 34A are each meshed (engaged) with the respective worms 32 of the motors 30. Thus the worm wheels 34A are rotated by driving each of the motors 30 so as to rotate the worms 32, and the wheel drives 34 are rotated.

A predetermined number (four in the present exemplary embodiment) of meshing claws 34B, which serve as engaging portions, are formed to an inner peripheral portion of each of the wheel drives 34 at the vehicle rear side of the worm wheel 34A. The predetermined number of meshing claws 34B are disposed at even spacings around the circumferential direction of the wheel drive 34. The meshing claws 34B extend toward the vehicle rear side and are elastic. Leading ends (vehicle rear side ends) of the meshing claws 34B project toward the radial direction inside of the respective wheel drives 34.

A rod drive 36, which has a substantially circular column shape made from resin and serves as a moving member is coaxially inserted inside each of the wheel drives 34. Each rod drive 36 projects through the covering wall 16C toward the vehicle rear side. One of the rod drives 36 is disposed above (or alternatively below) a center axis line of the support wall 16B of the visor body 16. The other of the rod drives 36 is disposed at the vehicle width direction outside (or alternatively at the vehicle width direction inside) of the center axis line of the support wall 16B.

Portions other than leading end portions (vehicle rear side end portions) of the rod drives 36 configure respective threads 36A. The leading ends of the meshing claws 34B of the wheel drives 34 are meshed (engaged) with the respective threads 36A. The leading end portions of the rod drives 36 have substantially spherical shapes. A peripheral face of the leading end portion of each of the rod drives 36 configures a leading end face 36B (slide face) having a substantially spherical face shape.

A mirror body 38, which serves as a visual recognition means, is housed inside the housing wall 16A and inside the support wall 16B of the visor body 16. The entire periphery and vehicle front side of the mirror body 38 is covered by the visor body 16. A mirror main body 38A made of resin is provided inside the mirror body 38. Film shaped metal (for example chrome) plating 38B configuring a surface portion is formed over the entire surface of the mirror main body 38A.

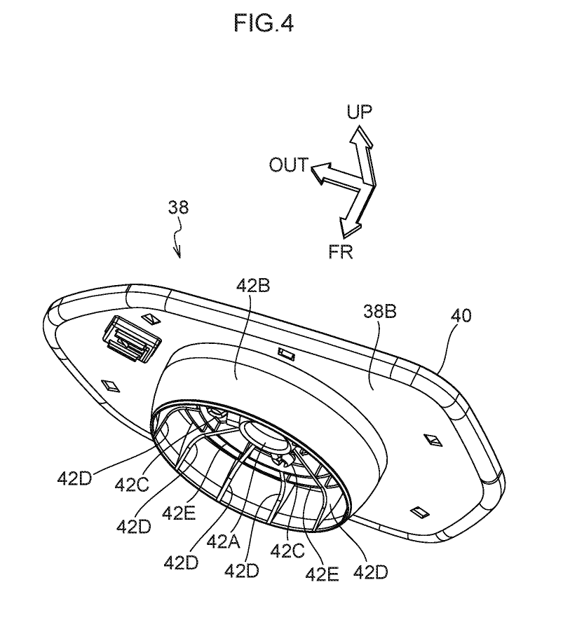

As illustrated in detail in FIG. 4, a mirror 40, which has a substantially rectangular plate shape and serves as a visual recognition portion, is provided at a vehicle rear side portion of the mirror body 38. A mirror face 40A is formed over the entire vehicle rear side face (surface side face) of the mirror 40 by the plating 38B. The mirror face 40A is exposed at the vehicle rear side of the visor body 16, is oriented toward the vehicle rear side, and visual recognition at the vehicle rear side by an occupant (in particular the driver) of the vehicle is assisted by the mirror face 40A.

An attachment wall 42A, which has a substantially cylindrical shape and serves as a sliding portion (inner sliding portion) and a reinforcing portion, is provided to the mirror body 38 at a vehicle front side (back side) of a central position (center of gravity position) of the mirror 40. The attachment wall 42A is disposed coaxially to the support wall 16B of the visor body 16. The attachment wall 42A has a substantially spherical wall profile and an inner peripheral face of the attachment wall 42A projects out toward the mirror 40. At a vehicle front side portion of the attachment wall 42A, an inner diameter dimension of the attachment wall 42A gradually increases on progression toward the vehicle rear. The retention ball 22A of the retention tube 22 of the visor body 16 is fit-inserted inside the attachment wall 42A. The inner peripheral face (slide face) of the attachment wall 42A is thereby retained on the retention face 22B of the retention ball 22A so as to be capable of tilting and sliding. The attachment wall 42A is disposed so as to be substantially perpendicular to the mirror 40, and the attachment wall 42A reinforces the mirror 40.

A sliding wall 42B, which has a substantially cylindrical shape and serves as a sliding portion (outer sliding portion) and a reinforcing portion, is provided to a vehicle front side portion of the mirror body 38 at the vehicle front side of the mirror 40 and the radial direction outside of the attachment wall 42A. The sliding wall 42B is disposed coaxially to the support wall 16B of the visor body 16. The sliding wall 42B has a spherical wall profile, and an external diameter dimension of the sliding wall 42B gradually increases on progression toward the vehicle rear. An outer peripheral face (sliding face) of the sliding wall 42B abuts the projection end faces 16H of the support protrusions 16G of the support wall 16B, and the sliding wall 42B is supported by the projection end faces 16H of the support protrusions 16G so as to be capable of tilting and sliding. The sliding wall 42B is disposed so as to be substantially perpendicular to the mirror 40, and the sliding wall 42B reinforces the mirror 40.

The mirror body 38 is provided with two pairs of swivel walls 42C, which each have a substantially cylindrical shape and serve as a sliding portion (moving portion) and a reinforcing portion, formed at the vehicle front side of the mirror 40 between the attachment wall 42A and the sliding wall 42B. One of the swivel wall 42C pairs is disposed above and below the center axis line of the support wall 16B of the visor body 16. The other of the swivel wall 42C pairs is disposed at the vehicle width direction outside and the vehicle width direction inside of the center axis line of the support wall 16B. The swivel walls 42C are disposed with their center axis lines parallel to the center axis line of the support wall 16B of the visor body 16. The swivel walls 42C each have a substantially spherical wall profile and an inner peripheral face that projects outs toward the mirror 40 side. An inner diameter dimension of the swivel walls 42C gradually increases on progression from the two vehicle front-rear direction end sides of the swivel walls 42C toward the vehicle front-rear direction center thereof. The swivel walls 42C are disposed so as to be substantially perpendicular to the mirror 40, and the swivel walls 42C reinforce the mirror 40.

The leading end portions of the rod drives 36 of the mirror face adjustment mechanism 28 are fit-inserted into and retained by the swivel walls 42C at the upper side and the vehicle width direction outside. The swivel walls 42C permit swiveling with respect to the leading end portions of the respective rod drives 36 and restrict axial rotation of the rod drives 36 in a state in which the inner peripheral faces (sliding faces) of the swivel walls 42C have been fitted together with the leading end faces 36B of the rod drives 36. Moreover, axial rotation of the rod drives 36 is restricted. Thus, as stated above, in the mirror face adjustment mechanism 28, as the wheel drives 34 (including the meshing claws 34B) are rotated, the meshing position of the leading ends of the meshing claws 34B with the threads 36A of the respective rod drives 36 is displaced, and the respective rod drives 36 are moved (slide) in the vehicle front-rear direction (axial direction).

A predetermined number of reinforcing plates 42D, which each have a substantially triangular plate shape and serve as reinforcing portions, are provided to the mirror body 38 at the vehicle front side of the mirror 40 between the attachment wall 42A and the sliding wall 42B. The predetermined number of reinforcing plates 42D each extend in a radial direction of the attachment wall 42A and the sliding wall 42B, and are disposed at even spacings around the circumferential direction of the attachment wall 42A and the sliding wall 42B. The reinforcing plates 42D are integrally formed to the mirror 40, the attachment wall 42A, and the sliding wall 42B, and are disposed so as to be perpendicular to the mirror 40, the attachment wall 42A, and the sliding wall 42B. The reinforcing plates 42D reinforce the mirror 40 and the sliding wall 42B. Predetermined reinforcing plates 42D are integrally formed to the swivel walls 42C, and are disposed so as to be perpendicular to the swivel walls 42C. The predetermined reinforcing plates 42D reinforce the swivel walls 42C (see FIG. 2). Note that the predetermined reinforcing plates 42D are not provided to the inside of the swivel walls 42C, and a projection amount of the predetermined reinforcing plates 42D from the mirror 40 is made smaller in the vicinity of the swivel walls 42C.

A predetermined number of reinforcing cylinders 42E, which each have a substantially circular cylindrical shape and serve as reinforcing portions, are provided to the mirror body 38 at the vehicle front side of the mirror 40 between the attachment wall 42A and the sliding wall 42B. The predetermined number of reinforcing cylinders 42E are each disposed coaxially to the attachment wall 42A and the sliding wall 42B, and are disposed spaced apart from each other in the radial direction of the attachment wall 42A and the sliding wall 42B. The reinforcing cylinders 42E are integrally formed to the mirror 40 and the reinforcing plates 42D, and are disposed so as to be perpendicular to the mirror 40 and the reinforcing plates 42D. The reinforcing cylinders 42E reinforce the mirror 40 and the reinforcing plates 42D.

Explanation follows regarding operation of the present exemplary embodiment.

In the vehicle door mirror device 10 configured as described above, the swing body 12B swings with respect to the stand 12A by electrical operation of the stowing mechanism 12, and the mirror body 38 (including the visor 14 (the visor body 16 and the visor cover 20), the reinforcement 24, and the mirror face adjustment mechanism 28) swing as a unit with the swing body 12B. The mirror body 38 thereby swings toward the vehicle rear side and the vehicle width direction inside, and the mirror body 38 is stowed. Moreover, the mirror body 38 is flipped out (deployed, returned) by the mirror body 38 being swung toward the vehicle front side and the vehicle width direction outside.

Moreover, when the motors 30 are driven by electrically operating the mirror face adjustment mechanism 28 so as to rotate the worms 32, the wheel drives 34 are rotated, and the rod drives 36 are moved in the vehicle front-rear direction. Thus, by the mirror body 38 being tilted by the rod drives 36 in at least one of the up-down direction or the vehicle width direction, the angle of the mirror face 40A of the mirror body 38 (mirror 40) (i.e. the visual recognition direction of the occupant assisted by the mirror face 40A) is adjusted in at least one of the up-down direction or the vehicle width direction.

When tilting the mirror body 38, the inner peripheral face of the attachment wall 42A of the mirror body 38 is retained (supported) while sliding over the retention face 22B of the retention ball 22A in the retention tube 22 of the visor body 16, and the outer peripheral face of the sliding wall 42B of the mirror body 38 is supported while sliding over the projection end faces 16H of the support protrusions 16G of the support wall 16B of the visor body 16. The inner peripheral faces of the swivel walls 42C of the mirror body 38 slide over the leading end faces 36B of the rod drives 36.

Note that the plating 38B is formed on the surface of the mirror body 38 at the perimeter of the mirror face 40A and at the opposite side from the mirror face 40A (i.e. the back side). This enables the plating 38B to reinforce the mirror 40, enables the rigidity of the mirror face 40A to be increased, enables juddering of the mirror face 40A to be suppressed, and enables visual recognition by the occupant using the mirror face 40A to be enhanced.

In the mirror body 38, the attachment wall 42A, the sliding wall 42B, the swivel walls 42C, the reinforcing plates 42D, and the reinforcing cylinders 42E are integrally formed to the mirror 40, and the attachment wall 42A, the sliding wall 42B, the swivel walls 42C, the reinforcing plates 42D, and the reinforcing cylinders 42E reinforce the mirror 40. Moreover, the plating 38B is formed on the surfaces of the attachment wall 42A, the sliding wall 42B, the swivel walls 42C, the reinforcing plates 42D, and the reinforcing cylinders 42E. This enables the attachment wall 42A, the sliding wall 42B, the swivel walls 42C, the reinforcing plates 42D, and the reinforcing cylinders 42E to be reinforced by the plating 38B, enabling the attachment wall 42A, the sliding wall 42B, the swivel walls 42C, the reinforcing plates 42D, and the reinforcing cylinders 42E to effectively reinforce the mirror 40. This enables the rigidity of the mirror face 40A to be effectively increased, enables juddering of the mirror face 40A to be effectively suppressed, and enables visual recognition by the occupant using the mirror face 40A to be effectively enhanced.

In the mirror body 38, the reinforcing plates 42D and the reinforcing cylinders 42E are integrally formed to the attachment wall 42A, the sliding wall 42B, and the swivel walls 42C, and the reinforcing plates 42D and the reinforcing cylinders 42E reinforce the attachment wall 42A, the sliding wall 42B, and the swivel walls 42C. The plating 38B is formed to the surfaces of the reinforcing plates 42D and the reinforcing cylinders 42E. This enables the reinforcing plates 42D and the reinforcing cylinders 42E to be reinforced by this plating 38B, enables the reinforcing plates 42D and the reinforcing cylinders 42E to effectively reinforce the attachment wall 42A, the sliding wall 42B, and the swivel walls 42C, and enables the rigidity of the attachment wall 42A, the sliding wall 42B, and the swivel walls 42C to be increased.

The plating 38B is also formed on the inner peripheral face of the attachment wall 42A. This enables sliding resistance to be reduced when the inner peripheral face of the attachment wall 42A slides over the retention face 22B of the retention ball 22A of the visor body 16 (retention tube 22), enabling the tilting performance of the mirror body 38 to be improved.

The plating 38B is also formed on the outer peripheral face of the sliding wall 42B. This enables sliding resistance to be reduced when the outer peripheral face of the sliding wall 42B slides over the projection end faces 16H of the support protrusions 16G of the visor body 16 (support wall 16B), enabling the tilting performance of the mirror body 38 to be further improved.

The plating 38B is also formed to the inner peripheral faces of the swivel walls 42C. This enables sliding resistance to be reduced when the inner peripheral faces of the swivel walls 42C slide over the leading end faces 36B of the rod drives 36, enabling the tilting performance of the mirror body 38 to be further improved.

In the mirror body 38, the mirror 40, the attachment wall 42A, the sliding wall 42B, and the swivel walls 42C are integrally formed. This enables the number of components to be reduced, enabling costs to be reduced.

In the present exemplary embodiment, the attachment wall 42A, the sliding wall 42B, and the swivel walls 42C are integrally formed to the mirror 40. However, it is sufficient that at least one of the attachment wall 42A, the sliding wall 42B, or the swivel walls 42C is integrally formed to the mirror 40.

In the present exemplary embodiment, the vehicle door mirror device 10 (vehicle mirror device) is installed at the outside of a door of a vehicle. However, the vehicle mirror device may be installed at another position on a vehicle.

The entire content of the disclosure of Japanese Patent Application No. 2016-10833 filed on Jan. 22, 2016 is incorporated by reference in the present specification.

### EXPLANATION OF THE REFERENCE NUMERALS

10 vehicle door mirror device (vehicle mirror device)
16 visor body (support body)
16B support wall (outer support portion)
22 retention tube (inner support portion)
36 rod drive (moving member)
38 mirror body
38B plating (surface portion)
40A mirror face
42A attachment wall (sliding portion, reinforcing portion)
42B sliding wall (sliding portion, reinforcing portion)
42C swivel wall (sliding portion, reinforcing portion)
42D reinforcing plate (reinforcing portion)
42E reinforcing cylinder (reinforcing portion)

1. A vehicle mirror device comprising: a mirror body that is provided at a vehicle; a mirror face that is provided at the mirror body and that is configured by plating; and a sliding portion that is provided at the mirror body, that has plating provided at a surface thereof, and that slides when the mirror body is moved.

2. The vehicle mirror device of claim 1, further comprising an inner support portion that supports the sliding portion, which is provided at a central side of the mirror face of the mirror body.

3. The vehicle mirror device of claim 1, further comprising an outer support portion that supports the sliding portion, which is provided at an outer peripheral side of the mirror face of the mirror body.

4. The vehicle mirror device of claim 1, further comprising a moving member that engages with the sliding portion and that, by moving, moves the mirror body.

5. A vehicle mirror device comprising: a mirror body that is provided at a vehicle; a mirror face that is provided at the mirror body and that is configured by plating; and a surface portion that is provided on a surface of the mirror body at at least one of a perimeter of the mirror face or an opposite side from the mirror face, and that is configured by plating.

6. The vehicle mirror device of claim 1, further comprising a reinforcing portion that is provided at the mirror body, that reinforces the mirror face, and that has plating provided at a surface thereof.
